(19) United States
(12) Patent Application Publication
(10) Pub. No.: US 2025/0214545 A1
(43) Pub. Date: Jul. 3, 2025

(54) VARIABLE PART EXCHANGE APPARATUS

(71) Applicants: Hyundai Motor Company, Seoul (KR); Kia Corporation, Seoul (KR)

(72) Inventors: Jin Ho HWANG, Hwaseong-Si (KR); Jaeseung Lee, Hwaseong-Si (KR); Won Ki Song, Hwaseong-Si (KR); Hyungsik Choi, Hwaseong-Si (KR); Choon Taik Kim, Yongin-Si (KR)

(73) Assignees: Hyundai Motor Company, Seoul (KR); Kia Corporation, Seoul (KR)

(21) Appl. No.: 18/960,142

(22) Filed: Nov. 26, 2024

(30) Foreign Application Priority Data
Dec. 29, 2023 (KR) 10-2023-0197138

(51) Int. Cl. B60S 5/00; B25J 11/00

(52) U.S. Cl. CPC B60S 5/00; B25J 11/008

(57) ABSTRACT

A variable part exchange apparatus includes a variable part moving device including a lifting part that moves a variable part selectively mounted on a vehicle body up and down and a lifter moving part that moves the lifting part, and a variable part supply device that carries out the variable part to the variable part moving device or carries in the variable part moved from the lifter moving part.

### CROSS-REFERENCE TO RELATED APPLICATION

The present application claims priority to Korean Patent Application No. 10-2023-0197138 filed on Dec. 29, 2023, the entire contents of which is incorporated herein for all purposes by this reference.

### BACKGROUND OF THE PRESENT DISCLOSURE

### Field of the Present Disclosure

The present disclosure relates to a variable part exchange apparatus. More particularly, the present disclosure relates to a variable part exchange apparatus configured for rapid exchange of variable parts.

### Description of Related art

Recently, the vehicle industry is introducing a new concept of future mobility vision for realizing a human-centered, dynamic future city. One of these future mobility solutions is a Purpose Built Vehicle (PBV) as purpose-based mobility.

A PBV may be an example of an electric vehicle (EV)-based environment-friendly mobile vehicle. This PBV can provide various customized services to users while moving from the starting point to the destination in an unmanned autonomous driving method.

PBV may be configured in various forms depending on the type of customized service. For example, PBV may be used as a hailing type vehicle that configures a cabin to transport occupants. Furthermore, the PBV may be utilized as a cab type vehicle with a cabin configured only in the front part of the upper body, or as a delivery type vehicle with a cabin configured in the front part of the upper body and a luggage compartment configured in the rear part.

However, if the body type may be easily changed according to the vehicle's intended use, the entire usability of the vehicle may be further increased.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a variable part exchange apparatus that can automatically combine and separate variable parts of a vehicle to increase the utility value of the vehicle.

A variable part exchange apparatus according to various exemplary embodiments of the present disclosure may include a variable part moving device including a lifting part that moves a variable part selectively mounted on a vehicle body up and down and a lifter moving part that moves the lifting part, and a variable part supply device that carries out the variable part to the variable part moving device or carries in the variable part moved from the lifter moving part.

The variable part supply device may include a first loading stage for carrying in the variable part moved from the variable part moving device, a second loading stage for carrying out the variable part to the variable part moving device, and a loading stage arranging portion that aligns the position of the first loading stage or the second loading stage to correspond to the position of the variable part moving device.

The loading stage arranging portion may include an arranging portion drive motor, and an arranging portion guide portion disposed in the vertical direction of the variable part moving device to move the positions of the first loading stage and the second loading stage according to the operation of the arranging portion drive motor.

The variable part supply device may further include a loading stage moving part that protrudes the first loading stage and the second loading stage in the direction of the variable part moving device or moves them away from the variable part moving device.

The loading stage moving part may include an upper loading panel provided with the variable part, a lower loading panel provided in the loading stage arranging portion, a stage moving part drive motor, and a moving part guide rail that moves the upper loading panel on the lower loading panel according to operation of the stage moving part drive motor.

The moving part guide rail may include a telescopic rail.

The loading stage moving part may further include a stage align pin mounted on the upper loading panel to align the position of the variable part.

The lifting part may include a vertical driving robot, and a variable part lifter that moves the variable part in the vertical direction by the operation of the vertical driving robot.

The lifting part may further include a guide post that guides the movement of the variable part lifter.

The lifting part may further include a lifter align pin mounted on the variable part lifter to align the position of the variable part.

The lifting part may further include an upper plate on which the variable part lifter is mounted and which moves in the vertical direction together with the variable part lifter.

The lifter moving part may include a lifter moving robot, and a lifter moving rail that guides the movement of the lifting part according to the operation of the lifter moving robot.

The variable part exchange apparatus according to according to various exemplary embodiments of the present disclosure may further include a pitch moving part that brings the variable part adjacent to or separates the variable part from the vehicle body.

The variable part exchange apparatus according to various exemplary embodiments of the present disclosure may automatically combine and separate the variable parts of a vehicle.

According to various exemplary embodiments of the present disclosure, the variable part exchange apparatus can increase the utility value of the vehicle by enabling rapid replacement of variable parts.

Furthermore, the effects which may be obtained or expected from embodiments of the present disclosure are directly or implicitly included in the detailed description of the exemplary embodiments of the present disclosure. That is, various effects predicted according to exemplary embodiments of the present disclosure will be included in the detailed description to be provided later.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a perspective view of a variable part exchange apparatus according to various exemplary embodiments of the present disclosure.

FIG. 2 is a top plan view of the variable part exchange apparatus according to various exemplary embodiments of the present disclosure.

FIG. 3 is a perspective view of a pitch moving part which may be applied to the variable part exchange apparatus according to various exemplary embodiments of the present disclosure.

FIG. 4 is a drawing showing the operation of the pitch moving part which may be applied to a variable part exchange apparatus according to various exemplary embodiments of the present disclosure.

FIG. 5 is a perspective view of a variable part moving device which may be applied to a variable part exchange apparatus according to various exemplary embodiments of the present disclosure.

FIG. 6 is a front view of the variable part moving device which may be applied to the variable part exchange apparatus according to various exemplary embodiments of the present disclosure.

FIG. 7 is a rear view of a variable part supply device which may be applied to the variable part exchange apparatus according to various exemplary embodiments of the present disclosure.

FIG. 8 is a perspective view of a loading stage moving part of a variable part supply device which may be applied to the variable part exchange apparatus according to various exemplary embodiments of the present disclosure.

FIG. 9 is a perspective view showing the operation of the loading stage moving part which may be applied to the variable part exchange apparatus according to various exemplary embodiments of the present disclosure.

FIG. 10 and FIG. 11 are drawings showing the operation of the variable part supply device which may be applied to the variable part exchange apparatus by embodiments. According to various exemplary embodiments of the present disclosure.

FIG. 12, FIG. 13, FIG. 14, FIG. 15 and FIG. 16 are drawings showing the operation of the variable part exchange apparatus to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, predetermined dimensions, orientations, locations, and shapes will be determined in part by the particularly intended application and use environment.

In the figures, reference numbers refer to the same or equivalent portions of the present disclosure throughout the several figures of the drawing.

The drawings referenced above are not necessarily drawn to scale, but should be understood as presenting a somewhat simplified representation of various exemplary features illustrating the basic principles of the present disclosure. The predetermined design features of the present disclosure, including, for example, predetermined dimensions, orientation, location, and shape, will be determined in part by the intended application and usage environment.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, with reference to the appended drawings, various exemplary embodiments of the present disclosure will be described in detail so that those skilled in the art can easily implement the present disclosure.

As those skilled in the art would realize, the described embodiments may be modified in various different ways, all without departing from the spirit or scope of the present disclosure.

To clearly explain an exemplary embodiment of the present disclosure, portions irrelevant to the description are omitted, and the same reference numerals are used for identical or similar components throughout the specification.

The size and thickness of each component shown in the drawings are arbitrarily shown for convenience of explanation, and the present disclosure is not necessarily limited to what is shown in the drawings. To clearly express various parts and areas, the thickness is shown by enlarging it.

Furthermore, the names of the components in the detailed description below are distinguished as first, second, etc., to distinguish them as they include the same relationship, and the description below is not necessarily limited to that order.

Throughout the specification, whenever a part is said to include or comprises a certain component, this does not mean that it excludes other components, but rather that it may include other components, unless otherwise specifically stated.

Additionally, terms such as “means”, “part”, “unit”, etc., described in the specification mean a comprehensive unit that is configured to perform at least one function or operation.

When we say that a part, such as a layer, membrane, region, or plate, is “on top of” another part, this includes not only cases where it is directly on top of the other part, but also cases where there are other parts in between.

In contrast, when an element is referred to as being “directly on” another element, there are no intervening elements present.

In the present specification, the term ‘connected’ indicates a physical relationship between two components in which the components are directly connected to each other by welding, rivets, Self Piercing Rivet (SPR), Flow Drill Screw (FDS), structural adhesive, etc., or indirectly connected through one or more intermediate components.

As used herein, ‘vehicle’, ‘vehicular’, ‘automotive’ or other similar terms as used herein generally refer to passenger vehicles, sports cars, sports utility vehicles (SUVs), buses, trucks, and various commercial vehicles including passenger vehicles, hybrid vehicles, electric vehicles, hybrid electric vehicles, electric vehicle-based Purpose built vehicles (PBVs), hydrogen-powered vehicles and other alternative fuel vehicles (e.g., other than petroleum fuel derived from resources).

In the present specification, the ‘front to rear direction of the vehicle body’ may be defined as the longitudinal direction of the vehicle body, the ‘vehicle width direction’ may be defined as the left and right direction of the vehicle body, and the ‘up-and-down direction’ may be defined as the height direction of the vehicle body.

In the present specification, ‘upper end’, ‘upper portion’, or ‘upper surface’ of a component indicates an end, portion, or surface of a component that is relatively upper in the drawing, and ‘lower end’, ‘lower portion’, or ‘lower surface’ of a component indicates an end, portion, or surface of a component that is relatively lower in the drawing.

Furthermore, in the present specification, an end of a component (e.g., one end or another (other) end, etc.) denotes an end of a component in any one direction, and an end portion of the component (e.g., one end portion) or other (another) end portion, etc.) denotes a portion of a component that includes that end.

An exemplary embodiment will hereinafter be described in detail with reference to the accompanying drawings.

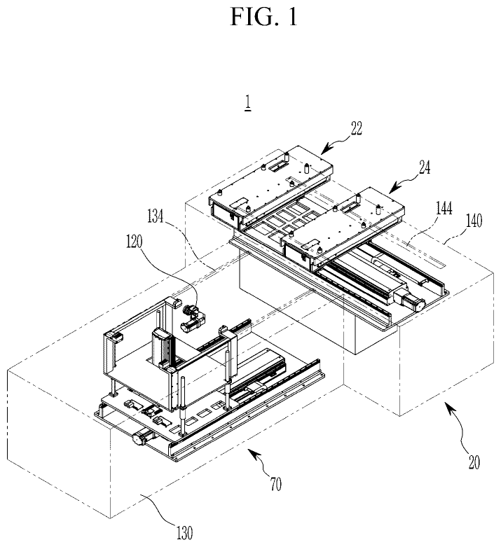

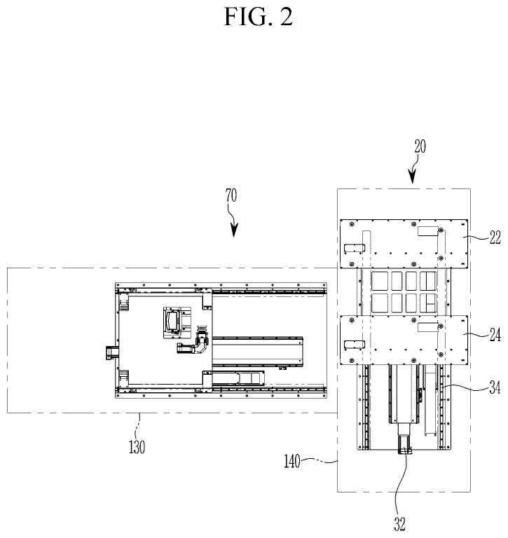

FIG. 1 is a perspective view of a variable part exchange apparatus according to various exemplary embodiments of the present disclosure, and FIG. 2 is a top plan view of the variable part exchange apparatus according to various exemplary embodiments of the present disclosure.

Referring to FIG. 1 and FIG. 2, a variable part exchange apparatus 1 according to various exemplary embodiments of the present disclosure may include a variable part moving device 70, and a variable part supply device 20 for carrying out a variable part 14, described below, from the variable part moving device 70, or for carrying in the variable part 14 moved from the variable part moving device 70.

The variable part moving device 70 is configured to move a separated variable part 14 to the variable part supply device 20 or to move the variable part 14 to be changed from the variable part supply device 20 to be mounted on a vehicle body.

The variable part supply device 20 is configured to receive the variable part 14 moved from the variable part moving device 70 and supply the variable part 14 to be changed to the variable part moving device 70.

The variable part supply device 20 and the variable part moving device 70 may be provided in a supply device housing 140 and a moving device housing 130, respectively.

A supply guide hole 144 for moving a loading stage, which will be described later, may be formed in the supply device housing 140, and a moving guide hole 134 for moving a lifting part 80, which will be described later, may be formed in the moving device housing 130.

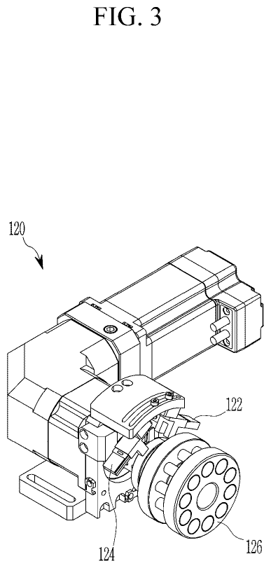

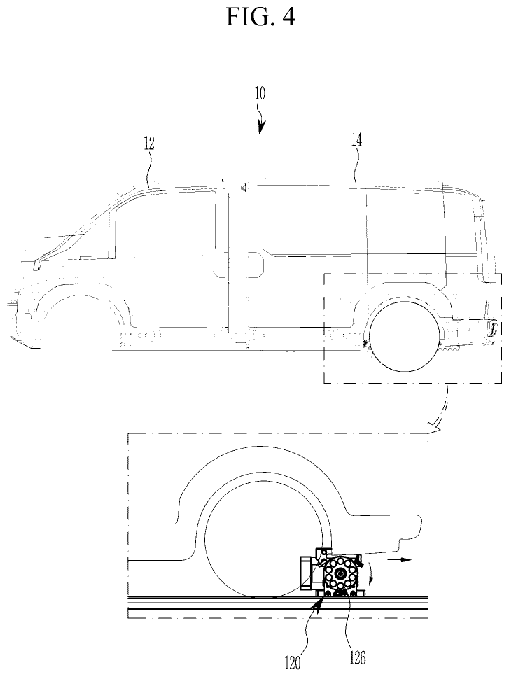

FIG. 3 is a perspective view of a pitch moving part which may be applied to the variable part exchange apparatus according to various exemplary embodiments of the present disclosure, and FIG. 4 is a drawing showing the operation of the pitch moving part which may be applied to a variable part exchange apparatus according to various exemplary embodiments of the present disclosure.

Referring to FIG. 3 and FIG. 4, a vehicle body 10 to which the variable part exchange apparatus 1 may be applied may include a fixed part 12 and the variable part 14.

The fixed part 12 may include, for example, a driver's seat and may be a configuration coupled with a frame that drives the vehicle.

The variable part 14 may be a hailing type cabin for transporting occupants, or a delivery type configuration for transporting cargo with a luggage compartment.

A general vehicle may be used only for limited purposes depending on the type produced, but a vehicle body 10 to which the variable part exchange apparatus 1 may be applied is produced separately according to the variable part exchange apparatus 1.

The variable part exchange apparatus 1 according to various exemplary embodiments of the present disclosure may automatically and rapidly exchange the variable part 14 produced in various types according to the purpose, further improving the usability of the vehicle.

According to various exemplary embodiments of the present disclosure, the vehicle body 10 to which the variable part exchange apparatus 1 may be applied may include an engage unit that selectively engages and releases the fixed part 12 and the variable part 14, and the engage unit may be configured to engage and release the fixed part 12 and the variable part 14 by mechanical actuation, or may be configured to engage or release by applying a magnetic force.

Furthermore, the variable part 14 may be engaged and released with the frame of the vehicle body 10, and the configuration for such engagement and release of the vehicle body 10 and the variable part 14 is beyond the gist of the present disclosure, so a detailed description thereof is omitted.

According to various exemplary embodiments of the present disclosure, the variable part exchange apparatus 1 may further include a pitch moving part 120 that brings the variable part 14 adjacent to or separates the vehicle body 10 from the vehicle body.

The pitch moving part 120 may be configured to be operated by a motor, for example, and may include a backward sensor 122, a forward sensor 124, and a pinion gear 126.

The pitch moving part 120 may be mounted on the moving device housing 130.

When the vehicle body 10, in which the fixed part 12 and the variable part 14 are combined, moves and is positioned on the pitch moving part 120, an engage unit is driven so that the variable part 14 releases its engagement with the vehicle body 10, i.e., the fixed part 12.

In the present state, the pinion gear 126 of the pitch moving part 120 operates to move the variable part 14.

This operation may be defined as a pitch release movement, and the backward sensor 122 detects the pitch release movement.

For example, the pitch release movement may be performed by approximately 10 mm to 20 mm.

Afterwards, the variable part moving device 70 moves the variable part 14 to the variable part supply device 20.

Although not shown in the drawing, a gear configured for engaging the pinion gear 126 is coupled to the lower portion of the variable part 14, so that the variable part 14 may be moved by driving the pinion gear 126.

Conversely, in a process of combining the variable part 14, the variable part 14 supplied from the variable part supply device 20 is moved by the variable part moving device 70 onto the pitch moving part 120, and the pinion gear 126 operates to move the variable part 14 in the direction of the fixed part 12.

This operation may be defined as a pitch-coupled movement, and the forward sensor 124 detects the pitch-coupled movement.

Afterwards, the engage unit may be actuated to engage the variable part 14 with the vehicle body 10, i.e., the fixed part 12.

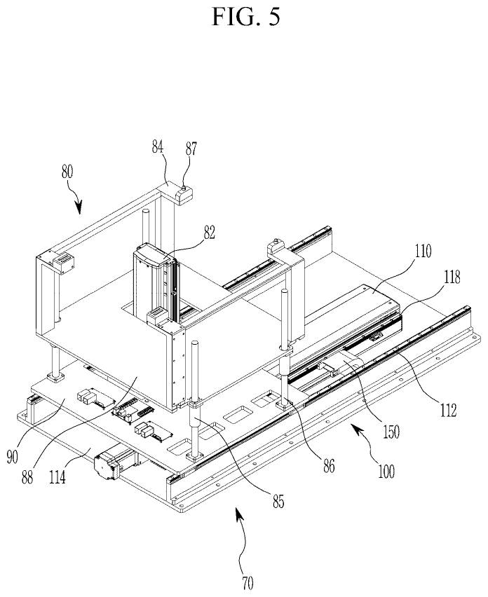

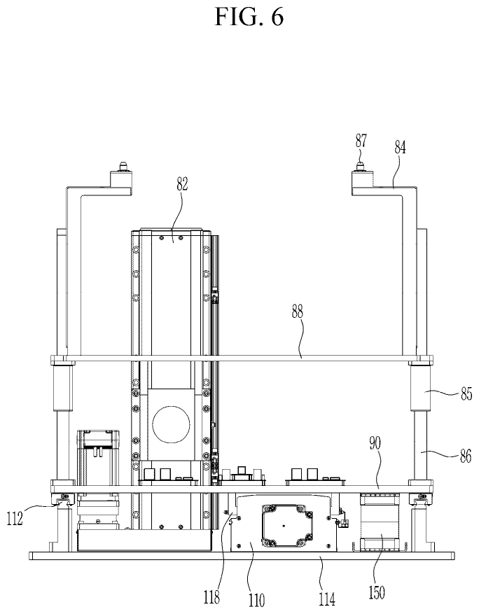

FIG. 5 is a perspective view of a variable part moving device which may be applied to a variable part exchange apparatus according to various exemplary embodiments of the present disclosure, and FIG. 6 is a front view of the variable part moving device which may be applied to the variable part exchange apparatus according to various exemplary embodiments of the present disclosure.

Referring to FIG. 5 and FIG. 6, the variable part moving device 70 may include a lifting part 80 for moving upwards and downwards the variable part 14, which is selectively mounted on the vehicle body 10, and a lifter moving part 100 for moving the lifting part 80.

The lifting part 80 may include a vertical driving robot 82 and a variable part lifter 84 that moves the variable part 14 in a vertical direction by operation of the vertical driving robot 82.

For example, the vertical driving robot 82 may be a motor-driven configuration, and the variable part lifter 84 supports the variable part 14 and moves in the vertical direction according to the operation of the vertical driving robot 82.

The lifting part 80 may further include a guide post 86 that guides the movement of the variable part lifter 84.

The guide post 86 may guide the movement of the variable part lifter 84 so that the variable part lifter 84 moves stably without shaking when the variable part lifter 84 moves in the vertical direction.

The lifting part 80 may further include a lifter align pin 87 mounted on the variable part lifter 84 to align the position of the variable part 14.

The lifter align pin 87 may align the position of the variable part 14 by engaging, for example, an align hole or groove formed at the bottom portion of the variable part 14.

The lifting part 80 may further include an upper plate 88 on which the variable part lifter 84 is mounted and which moves in the vertical direction together with the variable part lifter 84.

A middle plate 90 may be mounted on the lower part of the upper plate 88.

The guide post 86 may be mounted on the middle plate 90, and a post holder 85 into which the guide post 86 is inserted may be mounted on the upper plate 88.

The vertical driving robot 82 is connected to the upper plate 88, and the upper plate 88 moves up and down according to the operation of the vertical driving robot 82, and the variable part lifter 84 mounted on the upper plate 88 may also move up and down together.

The guide post 86 mounted on the middle plate 90 may be inserted into the post holder 85 to guide the movement of the variable part lifter 84.

The vertical driving robot 82 is connected to the upper plate 88 with, for example, a linear motion (LM) guide and slide block to move the upper plate 88 up and down. Matters concerning the configuration of LM guides and slide blocks, etc., and their connection relationships, etc. are obvious to those skilled in the art, and thus a detailed explanation is omitted.

The lifter moving part 100 may include a lifter moving robot 110 and a lifter moving rail 112 that guides the movement of the lifting part 80 according to the operation of the lifter moving robot 110.

For example, the lifter moving robot 110 may be configured to be driven by a motor, and the lifting part 80 may move according to the operation of the lifter moving robot 110.

The lifter moving part 100 may include a base plate 114 supporting the lifter moving robot 110, and the lifter moving rail 112 may be connected to the base plate 114 to support the middle plate 90 of the lifting part 80.

The lifter moving part 100 may further include a center moving rail 118, and the center moving rail 118 may support the lower portion of the middle plate 90 to guide the movement of the middle plate 90.

The middle plate 90 may be moved according to the operation of the lifter moving robot 110, and the lifting part 80 may be moved accordingly.

The lifter moving robot 110 is connected to, for example, the middle plate 90 and an LM guide and slide block to move the middle plate 90. The configuration of the LM guide and the slide block and the connection relationship therebetween are obvious to those skilled in the art, and thus a detailed description thereof is omitted.

The base plate 114 may be provided with a cableveyor 150 (or cable carrier) for controlling the operation of the variable part moving device 70 and the pitch moving part 120 and supplying power thereto.

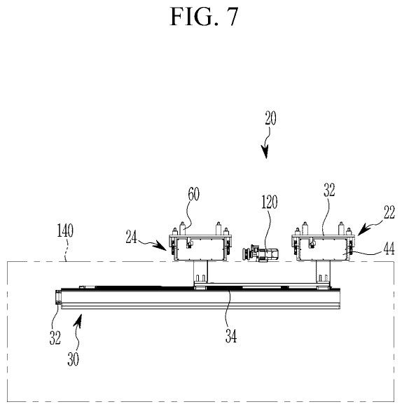

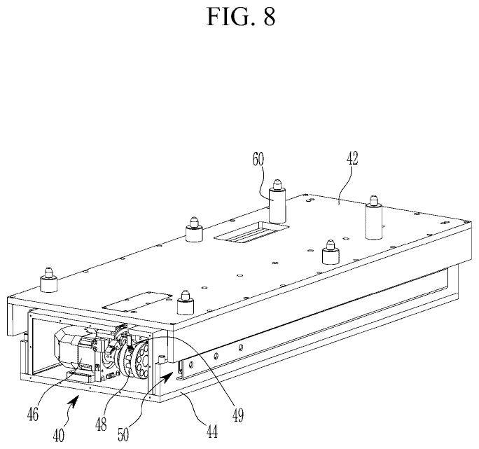

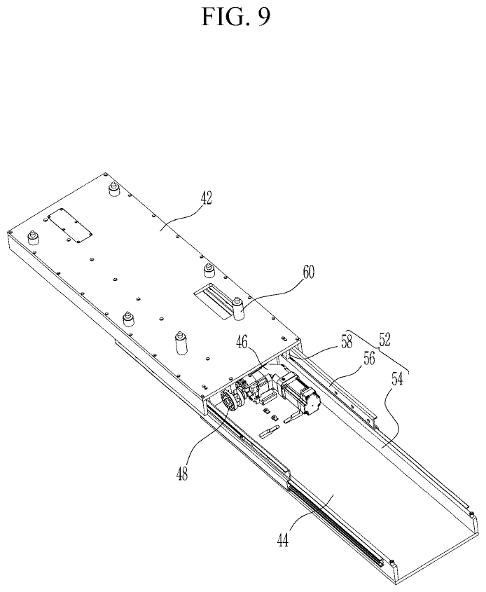

FIG. 7 is a rear view of a variable part supply device which may be applied to the variable part exchange apparatus according to various exemplary embodiments of the present disclosure, FIG. 8 is a perspective view of a loading stage moving part of a variable part supply device which may be applied to the variable part exchange apparatus according to various exemplary embodiments of the present disclosure, and FIG. 9 is a perspective view showing the operation of the loading stage moving part which may be applied to the variable part exchange apparatus according to various exemplary embodiments of the present disclosure.

Referring to FIG. 1, FIG. 2, FIG. 7, FIG. 8, and FIG. 9, the variable part supply device 20 may include a first loading stage 22 for importing the variable part 14 moved from the variable part moving device 70, a second loading stage 24 for exporting the variable part 14 to the variable part moving device 70, and a loading stage arranging portion 30 for aligning a position of the first loading stage 22 or the second loading stage 24 to correspond to a position of the variable part moving device 70.

The loading stage arranging portion 30 may include an arranging portion drive motor 32, and an arranging portion guide portion 34 disposed in a vertical direction of the variable part moving device 70 to move the positions of the first loading stage 22 and the second loading stage 24 according to the operation of the arranging portion drive motor 32.

For example, the arranging portion guide portion 34 may be a rail that supports the first loading stage 22 and the second loading stage 24 and guides the movement of the first loading stage 22 and the second loading stage 24.

The arranging portion drive motor 32 is connected to, for example, the first loading stage 22 and the second loading stage 24 and an LM guide and slide block to move the first loading stage 22 and the second loading stage 24. Matters regarding the configuration of the LM guide and the slide block and the connection relationship thereof are obvious to those skilled in the art, and thus a detailed description thereof is omitted.

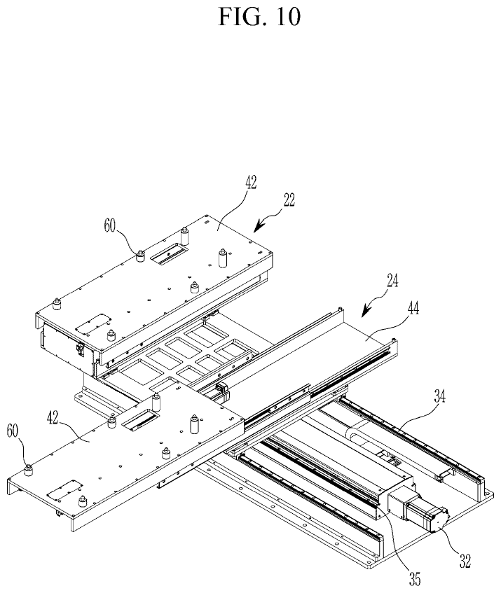

The loading stage arranging portion 30 may further include a center arranging guide portion 35 (see FIG. 10) supporting the first loading stage 22 and the second loading stage 24.

The center arranging guide portion 35 supports the lower portions of the first loading stage 22 and the second loading stage 24 and may guide the movement of the first loading stage 22 and the second loading stage 24.

The variable part supply device 20 may further include a loading stage moving part 40 that protrudes the first loading stage 22 and the second loading stage 24 in the direction of the variable part moving device 70 or moves the first loading stage 22 and the second loading stage 24 away from the variable part moving device 70.

The loading stage moving part 40 may include an upper loading panel 42 provided with the variable part 14, a lower loading panel 44 provided in the loading stage arranging portion 30, a stage moving part drive motor 46, and a moving part guide rail 50 that moves the upper loading panel 42 on the lower loading panel 44 according to operation of the stage moving part drive motor 46.

The moving part guide rail 50 may include, for example, a telescopic rail 52.

The telescopic rail 52 is configured to guide the relative movement of the upper loading panel 42 and the lower loading panel 44.

For example, the telescopic rail 52 may include a lower panel rail 54 mounted to the lower loading panel 44, an upper panel rail 58 mounted to the upper loading panel 42, and a connecting rail 56 connecting the lower panel rail 54 and the upper panel rail 58.

When the telescopic rail 52 is applied, the variable part 14 is stably supported, and the operation distance of the first loading stage 22 and the second loading stage 24 may be extended, avoiding interference with the variable part moving device 70.

A rack gear 49 is mounted on the lower part of the upper loading panel 42, and the stage moving part drive motor 46 is connected to a pinion gear 48 that engages the rack gear 49, so that the pinion gear 48 may be selectively rotated.

When the stage moving part drive motor 46 operates, the rack gear 49 moves in the longitudinal direction of the lower loading panel 44, and the upper loading panel 42 may move with the lower loading panel 44 as a reference.

The loading stage moving part 40 may further include a stage align pin 60 mounted on the upper loading panel 42 to align the position of the variable part 14.

The stage align pin 60 may align the position of the variable part 14 by engaging, for example, an align hole or groove formed at the bottom portion of the variable part 14.

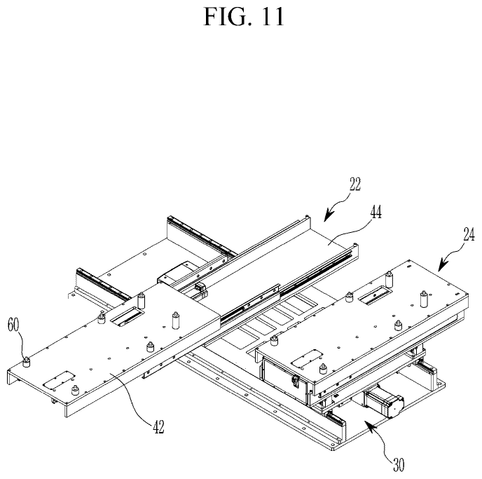

FIG. 10 and FIG. 11 are drawings showing the operation of the variable part supply device which may be applied to the variable part exchange apparatus by embodiments. According to various exemplary embodiments of the present disclosure.

Referring to FIG. 1, FIG. 2, FIG. 10 and FIG. 11, the loading stage arranging portion 30 operates to move the second loading stage 24 to correspond to the position of the variable part moving device 70, and then, by operation of the loading stage moving part 40, the second loading stage 24 is protruded in the direction of the variable part moving device 70.

Afterwards, after the variable part 14 moved by the variable part moving device 70 is settled on the second loading stage 24, the second loading stage 24 returns to the original position by operation of the loading stage moving part 40.

Thereafter, the loading stage arranging portion 30 operates to move the first loading stage 22, on which the previously provided variable part 14 to be changed is placed, to correspond to the position of the variable part moving device 70, and by operation of the loading stage moving part 40, the first loading stage 22 is protruded in the direction of the variable part moving device 70.

Afterwards, the variable part 14 loaded on the first loading stage 22 may be moved in the vehicle body 10 direction by operation of the variable part moving device 70.

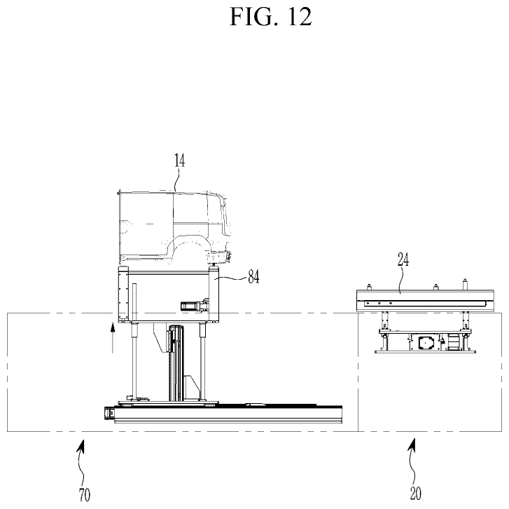

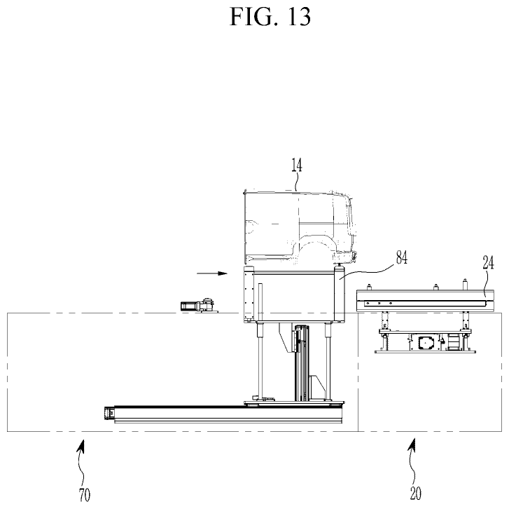

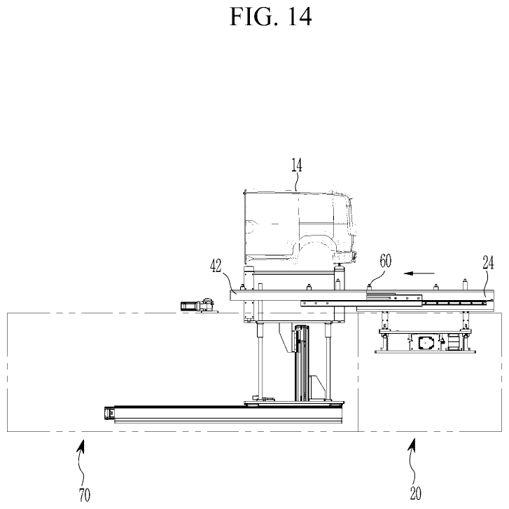

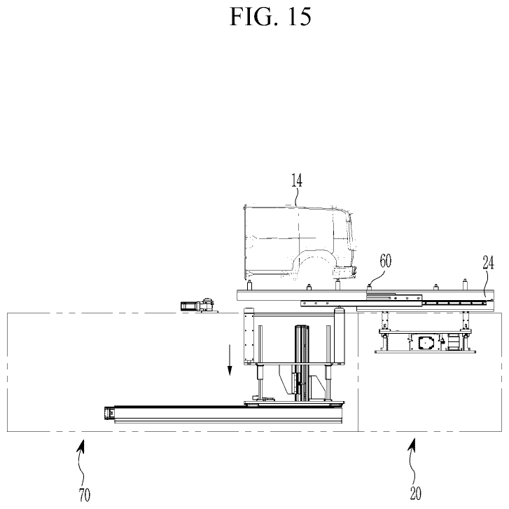

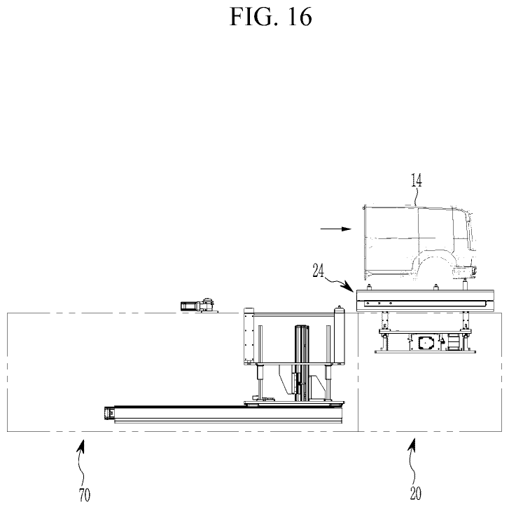

FIG. 12, FIG. 13, FIG. 14, FIG. 15 and FIG. 16 are drawings showing the operation of the variable part exchange apparatus to various exemplary embodiments of the present disclosure.

Referring to FIG. 1, FIG. 2, FIG. 3 and FIG. 4, when the vehicle body 10, in which the fixed part 12 and the variable part 14 are combined, moves and is positioned on the pitch moving part 120, an engage unit is driven so that the variable part 14 releases its engagement with the vehicle body 10, i.e., the fixed part 12.

In the present state, the variable part 14 moves in the rearward direction of the vehicle body 10 by operation of the pitch moving part 120 to perform the pitch release movement.

Accordingly, as shown in FIG. 12, the lifting part 80 of the variable part moving device 70 operates to raise the separated variable part 14.

And, as shown in FIG. 13, by operation of the lifter moving part 100 of the variable part moving device 70, the variable part 14 is moved adjacent to the variable part supply device 20.

At the present time, the variable part 14 is positioned above the second loading stage 24.

Referring to FIG. 14, through operation of the loading stage moving part 40, the second loading stage 24 is protruded in the variable part moving device 70 direction.

Referring to FIG. 15, by operation of the lifting part 80, the variable part lifter 84 is lowered and the variable part 14 is placed on the second loading stage 24.

As shown in FIG. 16, by operation of the loading stage moving part 40, the second loading stage 24 returns to the original position thereof.

Thereafter, the supply process of variable part 14 to be replaced is conducted in the opposite direction to the separation and storage process of variable part 14 described above.

That is, the loading stage arranging portion 30 operates to move the first loading stage 22, on which the previously provided variable part 14 to be changed is placed, to correspond to the position of the variable part moving device 70, and by operation of the loading stage moving part 40, the first loading stage 22 is protruded in the direction of the variable part moving device 70.

The variable part lifter 84 of the variable part moving device 70 adjacent to the variable part supply device 20 is raised by operation of the lifting part 80, and the variable part 14 is placed on the variable part lifter 84.

By operation of the lifter moving part 100, the variable part 14 moves in the vehicle body 10 direction, and by operation of the lifting part 80, the variable part lifter 84 descends to the state shown in FIG. 4.

Thereafter, by operation of the pitch moving part 120, the variable part 14 moves in the forward direction of the vehicle body 10 to perform the pitch coupling movement.

As described above, according to various exemplary embodiments of the present disclosure, the variable part exchange apparatus may automatically combine and separate variable parts of a vehicle.

According to various exemplary embodiments of the present disclosure, the variable part exchange apparatus may increase the usability of a vehicle by enabling rapid replacement of variable parts.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A variable part exchange apparatus comprising:
a variable part moving device including:
a lifting part that moves a variable part selectively mounted on a vehicle body up and down; and
a lifter moving part that moves the lifting part; and
a variable part supply device that carries out the variable part to the variable part moving device or carries in the variable part moved from the lifter moving part.

2. The variable part exchange apparatus of claim 1, wherein the variable part supply device includes:
a first loading stage for carrying in the variable part moved from the variable part moving device;
a second loading stage for carrying out the variable part to the variable part moving device; and
a loading stage arranging portion that aligns a position of the first loading stage or a position of the second loading stage to correspond to a position of the variable part moving device.

3. The variable part exchange apparatus of claim 2, wherein the loading stage arranging portion includes:
an arranging portion drive motor; and
an arranging portion guide portion disposed in a vertical direction of the variable part moving device to move the positions of the first loading stage and the second loading stage according to operation of the arranging portion drive motor.

4. The variable part exchange apparatus of claim 2, wherein the variable part supply device further includes a loading stage moving part that protrudes the first loading stage and the second loading stage in a direction of the variable part moving device or moves the first loading stage and the second loading stage away from the variable part moving device.

5. The variable part exchange apparatus of claim 4, wherein the loading stage moving part includes:
an upper loading panel provided with the variable part;
a lower loading panel provided in the loading stage arranging portion;
a stage moving part drive motor; and
a moving part guide rail that moves the upper loading panel on the lower loading panel according to operation of the stage moving part drive motor.

6. The variable part exchange apparatus of claim 5, wherein the moving part guide rail includes a telescopic rail.

7. The variable part exchange apparatus of claim 6, wherein the telescopic rail includes:
a lower panel rail mounted to the lower loading panel;
an upper panel rail mounted to the upper loading panel; and
a connecting rail connecting the lower panel rail and the upper panel rail.

8. The variable part exchange apparatus of claim 5, wherein the loading stage moving part further includes a stage align pin mounted on the upper loading panel to align the position of the variable part.

9. The variable part exchange apparatus of claim 1, wherein the lifting part includes:
a vertical driving robot; and
a variable part lifter that moves the variable part in a vertical direction by operation of the vertical driving robot.

10. The variable part exchange apparatus of claim 9, wherein the lifting part further includes a guide post that guides the movement of the variable part lifter.

11. The variable part exchange apparatus of claim 9, wherein the lifting part further includes a lifter align pin mounted on the variable part lifter to align a position of the variable part.

12. The variable part exchange apparatus of claim 9, wherein the lifting part further includes an upper plate on which the variable part lifter is mounted and which moves in a vertical direction together with the variable part lifter.

13. The variable part exchange apparatus of claim 1, wherein the lifter moving part includes:
a lifter moving robot; and
a lifter moving rail that guides the movement of the lifting part according to operation of the lifter moving robot.

14. The variable part exchange apparatus of claim 1, further includes a pitch moving part that brings the variable part adjacent to or separates the variable part from the vehicle body.

15. The variable part exchange apparatus of claim 14, wherein the pitch moving part includes a backward sensor, a forward sensor, and a pinion gear connected to a motor.
